(19) United States
(12) Patent Application Publication
(10) Pub. No.: US 2016/0083491 A1
(43) Pub. Date: Mar. 24, 2016

(54) CURABLE ACRYLIC COMPOSITION, ACRYLIC TAPE, ACRYLIC RUBBER ROLL AND METHOD FOR PREPARING THE ACRYLIC RUBBER ROLL

(71) Applicant: 3M INNOVATIVE PROPERTIES COMPANY, Saint Paul, MN (US)

(72) Inventors: Rongxia Yao, Shanghai (CN); Yu Sun, Shanghai (CN); Qing Wu, Shanghai (CN); Chao Teng, Shanghai (CN)

(21) Appl. No.: 14/891,728

(22) PCT Filed: May 14, 2014
(86) PCT No.: PCT/US2014/037970

§ 371 Date: Nov. 17, 2015

(30) Foreign Application Priority Data
May 20, 2013 (CN) 201310187526.0

(51) Int. Cl. C08F 220/18; C08J 5/12; A47L 25/00; C09J 7/00

(52) U.S. Cl. CPC C08F 220/18; C09J 7/00; C08J 5/128; A47L 25/005; C09J 133/08

(57) ABSTRACT

Disclosed is a curable acrylic composition, an acrylic tape, an acrylic rubber roll and a method for preparing the acrylic rubber roll. The acrylic composition contains 50-77 wt % 2-ethylhexyl acrylate, 2-10 wt % acrylic acid, 20-40 wt % 2-hydroxyethyl acrylate, 0.1-0.5 wt % curing agent and 0.1-0.2 wt % photoinitiator. The acrylic rubber roll formed by the acrylic composition can recover its viscosity if washed directly with clean water without cleanser, and is characterized by excellent cleaning ability and washability.

### TECHNICAL FIELD

The present disclosure relates to a curable acrylic composition, an acrylic tape, an acrylic rubber roll and a method for preparing the acrylic rubber roll.

### BACKGROUND

At present, dedusting adhesive tapes and rubber rolls, also referred to as lint rollers, can be used to clean various surface. Disposable dedusting adhesive tapes and rubber rolls are easy to use but are relatively high in cost. Reusable and water washable dedusting rubber rolls have become increasingly popular among price-sensitive and environmentally conscious consumers. Most water washable adhesive cleaning rolls in the market are composed of base materials such as natural rubber, synthetic rubber, silica gel or PVC, in which self-adhesive elastomer materials function as the adhesive layer and most of the surfaces are hydrophobic, resulting in unsatisfactory results when cleaning only with water, requiring cleansers or hot water to be when cleaning the rolls so as to reduce surface friction. Moreover, many cleansers are alkaline or acidic in nature and will cause damage to adhesive surfaces over long-term use. Therefore, using less or not using cleanser at all would be more in line with green, environmental protection, and safe to touch with hands. In addition, most washable rolls commercially available are characterized by large surface friction and difficult rolling, and are thereby difficult to be satisfactorily cleaned, or can even cause detachment or breakage to the support shaft of rolls, affecting the performance.

### SUMMARY

In order to solve the existing technological problems, disclosed is a curable acrylic composition, and an acrylic tape made from a curable acrylic composition and acrylic rubber roll composing said acrylic tape, wherein the acrylic rubber roll can recover its adhesion if washed with clean water without cleansers and is characterized by excellent cleaning ability and washability.

Compared with conventional reusable and washable rubber rolls, the embodiment of the present disclosure has great advantages. The acrylic rubber roll can recover its adhesion if directly washed with clean water without cleansers, and is characterized by excellent cleaning ability and washability, easy cleaning of soft surfaces, and removal of lint, dandruff, dust, bits of thread, and so on that are attached to soft surfaces of household textile products, thus lowering the frequency for cleaning household textile products, especially clothing. A particular benefit is that in the acrylic rubber roll disclosed, the surface loses adhesion and becomes smooth when exposed to water, and the dirt attached to the surface can be easily removed with water without cleansers, and the acrylic composition can recover its viscosity after removing the moisture on the surface, and can be reused, reducing environmental pollution. After being reused many times, the acrylic rubber roll is still provided with good adhesion and rubber surface appearance, wherein the rubber surface is well bonded with the attached plastic roll, and the rubber surface is less likely to be detached if washed with water.

In one embodiment, a curable acrylic composition is provided, which comprises 50-77 wt % 2-ethylhexyl acrylate, 2-10 wt % acrylic acid, 20-40 wt % 2-hydroxyethyl acrylate, 0.1-0.5 wt % curing agent and 0.1-0.2 wt % photoinitiator.

In one embodiment, the photoinitiator includes 2,2-dimethoxy-phenyl ketone.

In one embodiment, said curing agent is bifunctional acrylic ester. The bifunctional acrylic ester can include HDDA or TPGDA.

In one embodiment, the acrylic composition also includes one or more of: antiseptic, antibacterial agent, flavoring agent, plasticizer and fumed silica.

One embodiment provides an acrylic tape formed by curing said acrylic composition.

In one embodiment, said curing includes UV light curing.

One embodiment provides an acrylic rubber roll comprising a roll and said acrylic tape wrapped on the roll.

One embodiment provides a method for producing acrylic rubber rolls, which includes: mixing and stirring 50-77 wt % 2-ethylhexyl acrylate, 2-10 wt % acrylic acid, 20-40 wt % 2-hydroxyethyl acrylate, and 0.1-0.5 wt % curing agent at room temperature; adding 0.1-0.2 wt % photoinitiator into the mixture, and continuing to stir until the photoinitiator is fully dissolved to form the acrylic composition; irradiating the acrylic composition with UV-light to make it crosslink and cure to obtain an acrylic tape; cutting the acrylic tape model corresponding to the size of plastic rubber roll shaft, and sticking said acrylic tape evenly without air bubbles to the rubber roll that can rotate freely so as to get said acrylic rubber roll.

In the embodiment of method for producing the acrylic rubber roll, before irradiating the acrylic composition with UV-light, one or more antiseptic, antibacterial agent, flavoring agent, flavoring agent and fumed silica will be added into the acrylic composition.

In the embodiment of method for producing acrylic rubber rolls, the stated curing agent includes bifunctional acrylic ester.

In the embodiment of method for producing acrylic rubber rolls, the photoinitiator comprises 2,2-dimethoxy-phenyl ketone.

### DETAILED DESCRIPTION

In one embodiment, a curable acrylic composition is provided, comprising 50-77 wt % 2-ethylhexyl acrylate, 2-10 wt % acrylic acid, 20-40 wt % 2-hydroxyethyl acrylate, 0.1-0.5 wt % curing agent and 0.1-0.2 wt % photoinitiator.

The acrylic composition also comprises other additive such as mildew preventive, antibacterial agent and flavoring agent, such as fumed silica and A-200.

The curing agent has no special restrictions. The embodiment of the curing agent can include a bifunctional acrylic ester monomer such as HDDA and TPGDA.

The photoinitiator has no special restrictions. For example, the embodiment of the photoinitiator can be Irgacure 651.

The curable acrylic composition in the embodiment of the disclosure is formed by mixing 2-ethylhexyl acrylate, acrylic acid, 2-hydroxyethyl acrylate, curing agent and photoinitiator according to ratios.

In addition, the acrylic tape can be formed by curing the curable acrylic composition. UV-light can be used for curing.

In one embodiment, the acrylic rubber roll can be formed by wrapping the acrylic tape on the roll. The acrylic rubber roll can be used to clean surfaces of household textile products.

In one embodiment, acrylic composition can be applied on the roll, and then be crosslinked and cured to form the acrylic rubber roll used to clean surfaces of household textile products.

### EXAMPLES

The embodiment of the present disclosure is described by, but not limited to the following embodiments.

Typical raw materials used in embodiments and comparison cases are listed as follows:

| | 2-EHA | AA | HEA | Irgacure 651 | HDDA |
|---|---|---|---|---|---|
| Supplier | HYAYL | BASF | BASF | Ciba | Cytec |
| Type | 2-ethylhexyl acrylate | Acrylic acid | 2-Hydrocyethyl | Photoinitiator | Curing agent |
| | | | acrylate | | |
| Case No. | 103-11-7 | 79-10-7 | 818-61-1 | 24650-42-8 | 13048-33-4 |

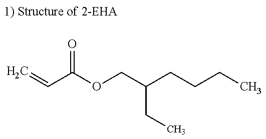

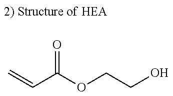

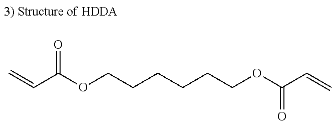 [SMILES: C=CC(=O)OCCCCCCOC(=O)C=C]

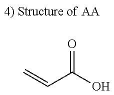

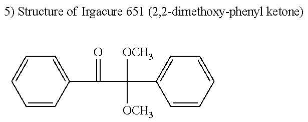 [SMILES: COC(OC)(C(=O)c1ccccc1)c1ccccc1]

### Embodiment 1

Homogeneously mix 2-EHA, AA, HEA, the curing agent HDDA and the Photoinitiator Irgacure 651 according to the ratios shown in Table 1 to obtain the curable acrylic composition. Specifically, pour liquid raw materials including 2-EHA, AA, HEA and the curing agent HDDA into a glass container at room temperature, stir said materials at a constant speed with a stirrer, then add photoinitiator Irgacure 651 powder and continue to stir said materials at a constant speed until the photoinitiator Irgacure 651 is completely dissolved.

Cure and crosslink the acrylic composition with a UV lamp and ensure the crosslinking reaction of monomers in the formula is thorough so as to form the acrylic tape.

Cut the acrylic tape model to the size of the plastic rubber roll shaft, and stick said acrylic tape evenly without air bubbles to the rubber roll that can rotate freely so as to form the acrylic rubber roll that can be used to remove dust and lint.

### Comparison Cases 1-2

A curable acrylic composition can be prepared with the same method in Embodiment 1. The difference lies in changing the ratios of 2-EHA, AA and HEA as shown in Table 1. Prepare the acrylic tape and the acrylic rubber roll with the curable acrylic composition prepared with same method in Embodiment 1.

### Embodiments 2-4

Prepare the curable acrylic composition with the same method in Embodiment 1. The difference lies in changing the ratios of 2-EHA, AA and HEA as shown in Table 1. Prepare the acrylic tape and the acrylic rubber roll with the curable acrylic composition prepared with the same method in Embodiment 1.

TABLE 1

| | 2-EHA | AA | HEA | HDDA | Irgacure 651 |
|---|---|---|---|---|---|
| Sample | (wt %) | (wt %) | (wt %) | (wt %) | (wt %) |
| Embodiment-1 | 56.5 | 3 | 40 | 0.3 | 0.2 |
| Comparison Case-1 | 76.5 | 4 | 19 | 0.3 | 0.2 |
| Embodiment-2 | 75.5 | 4 | 20 | 0.3 | 0.2 |
| Embodiment-3 | 53.5 | 6 | 40 | 0.3 | 0.2 |
| Comparison Case-2 | 72.5 | 8 | 19 | 0.3 | 0.2 |
| Embodiment-4 | 71.5 | 8 | 20 | 0.3 | 0.2 |

The acrylic tape and the acrylic rubber roll prepared in the embodiments and comparison cases are tested. The testing methods are as follows:

### Washing Test Method:

Select a suitable amount of lint and lay said lint on a flat surface. Gently contact the tested fresh rubber-surface with the lint and then quickly lift the sample up. Observe whether or not the lint is easily picked up by the rubber sample.

Place the rubber sample, now stuck with lint, under a faucet and wash the rubber surface with slow running water, gently wiping the lint off the adhesive surface with fingers. Keep the washing time controlled to 15 seconds or less. Turn off the tap and observe whether any lint remains on the adhesive surface.

The results obtained from this test are shown in Table 2.

TABLE 2
Results of Washing Test

| Sample | Appearance | Result |
|---|---|---|
| Embodiment-1 | Good transmittance, mildly hard rubber | Easy to wash, |
| | without air bubbles | no remaining lint |
| Comparison | Good transmittance, soft rubber without | Hard to wash, |
| Case-1 | air bubbles | remaining lint. |
| Embodiment-2 | Good transmittance, soft rubber without | Easy to wash, |
| | air bubbles | no remaining lint |
| Embodiment-3 | Good transmittance, mildly hard rubber | Easy to wash, |
| | without air bubbles | no remaining lint |
| Comparison | Good transmittance, soft rubber without | Hard to wash, |
| Case-2 | air bubbles | remaining lint. |
| Embodiment-4 | Good transmittance, soft rubber without | Easy to wash, |
| | air bubbles | no remaining lint |

### Initial Adhesion Test Method:

Refer to the standards of G1 ASTM D6195 for the initial adhesion test method. The samples include the fresh rubber samples and soaked rubber samples. The method for preparing soaked samples is to soak the whole rubber sample in clean water and remove after 30 minutes of soaking. Place the rubber sample in a room at 22° C. and humidity of 50% until the rubber sample is completely dry for testing.

The results obtained from this test are shown in Table 3.

TABLE 3
Results of Initial Adhesion Test:

| | Fresh sample | Soaked sample |
|---|---|---|
| Sample | (N/inch) | (N/inch) |
| Embodiment-1 | 19.31 | 11.32 |
| Comparison Case-1 | 15 | 7.36 |
| Embodiment-2 | 18.97 | 9.44 |
| Embodiment-3 | 16.26 | 9.2 |
| Comparison Case-2 | 14.32 | 5.6 |
| Embodiment-4 | 18.92 | 7.4 |

In the practical application of washable rubber rolls, initial adhesion is one of the most direct indexes indicating roll performance. Since concepts such as washing and reusability are involved in use, the initial adhesion retention of soaked rubber samples is important too. With initial adhesion tests on fresh samples and soaked samples, the performance of washable rubber rolls in practical applications can be simulated.

In practical applications, too great or small initial adhesion will affect practical using effects. According to test results, Embodiment-1, Embodiment-2 and Embodiment-3 have excellent initial adhesion retention, washing test results and initial adhesion test results for fresh samples and soaked samples.

### Washability Test:

The test sample measures 1 inch by 8 inches and is covered with standard dust. The sample is washed by hand with running water for about 15 seconds, then the water droplets are gently shaken off and the sample is allowed to stand for one minute in a 22° C. and 50% relative humidity environment. These steps are then repeated (dusting, cleaning, and rinsing) 150 times before being allowed to dry for 5 minutes. Then testing is performed on Embodiment-1, Comparison Case-1 and competing products (competing products are mostly produced by casting elastic materials such as synthetic rubber, polyurethane, and silica gel on a plastic roll shaft with a mould, and have names such as Sticky Lint Roller and Lint Cleaner, etc.) in accordance with G1 ASTM D6195.

After 150 cycles, the initial adhesion of Embodiment-1 remained nearly the same while that the competing products fell by about 50%. In addition, the initial adhesion of the rubber tape of Embodiment-1 is about 4 times greater than that of the competing product. The rubber tape of the embodiment of the present disclosure has long-lasting cleaning abilities for adhered dirt such as dust and lint. Compared with Embodiment-1, the washability data of the Comparison Case-1 falls off slightly.

TABLE 4
Comparison Test on Washability

| Comparison of initial adhesion, | | Competing |
|---|---|---|
| Unit: g/in, loop tack test method | Embodiment 1 | Product |
| Initial value (before rinsing) | 272.4 | 67.34 |
| After being used and rinsed | 263.26 | 35.71 |
| 150 times | | |

### Test of the Recovery Time of Adhesion

The roll diameter of the rubber roller is 56 mm and the roll is 98 mm long. The natural dry time after washing is the adhesion recovery time of the rubber roll.

TABLE 5
Adhesion Recovery Time
Natural dry time after washing

| | Natural dry time |
|---|---|
| | of rubber roll |
| | (min) |
| 1# | 19.0 |
| 2# | 17.0 |
| 3# | 22.0 |
| 4# | 13.0 |
| 5# | 18.0 |
| Average dry time (min.) | 17.8 |

In Table 5, 1#-5# are the 5 times sampling test results of Embodiment 1.

During practical application, consumers can reuse the rubber tape about 1 to 3 minutes later after the rubber tape surface is half dry. The adhesion is sufficient to remove dirt such as lint. The rubber tape can be used before the rubber surface is completely dry. Wiping away water drops with a piece of soft cloth or paper that does not leave scraps to speed up the adhesion recovery of rubber surface.

### Test Results on Washing Difficulty

TABLE 6

| | With cold | With | With |
|---|---|---|---|
| | running water | warm water | soapy water |
| Embodiment 1 | Easy to wash | Easy to wash | Easy to wash |
| Comparison Case 1 | Difficult to wash | Easy to wash | Easy to wash |
| Competing Product | Difficult to wash | Difficult to wash | Easy to wash |

1. A curable acrylic composition comprising:
50-77 wt % 2-ethylhexyl acrylate;
2-10 wt % acrylic acid;
20-40 wt % 2-hydroxyethyl acrylate;
0.1-0.5 wt % curing agent; and
0.1-0.2 wt % photoinitiator.

2. The acrylic composition according to claim 1, wherein the curing agent comprises a bifunctional acrylic ester.

3. The acrylic composition according to claim 1, wherein the photoinitiator comprises 2,2-dimethoxy-phenyl ketone.

4. The acrylic composition according to claim 2, wherein the bifunctional acrylic ester comprises HDDA or TPGDA.

5. The acrylic composition according to claim 1, wherein the acrylic composition also comprises one or more of: antiseptic, antibacterial agent, flavoring agent, plasticizer and fumed silica.

6. An acrylic tape formed by curing the acrylic composition according to claim 1.

7. The acrylic tape according to claim 6, wherein curing comprises ultraviolet (UV) light polymerization.

8. An acrylic rubber roll comprising a roller and the acrylic tape according to claim 6 wrapped on the roller.

9. A method for preparing an acrylic rubber roll, comprising:
mixing and stirring 50-77 wt % 2-ethylhexyl acrylate, 2-10 wt % acrylic acid, 20-40 wt % 2-hydroxyethyl acrylate, and 0.1-0.5 wt % curing agent at room temperature to form a mixture;
adding 0.1-0.2 wt % photoinitiator into the mixture, and continuing to stir until the photoinitiator is fully dissolved in order to form an acrylic composition;
irradiating the acrylic composition with UV light to crosslink and cure the acrylic composition in order to obtain an acrylic tape; and
cutting the acrylic tape according to a size of a plastic rubber roll shaft, and evenly sticking the acrylic tape to a freely-rotatable rubber roll while avoiding air bubbles so as to obtain the acrylic rubber roll.

10. The method for producing the acrylic rubber roll according to claim 9, further comprising:
before irradiating the acrylic composition with UV light, adding one or more of:
antiseptic, antibacterial agent, flavoring agent, plasticizer, and fumed silica into the acrylic composition.

11. The method for producing the acrylic rubber roll according to claim 9, wherein the curing agent comprises a bifunctional acrylic ester.

12. The method for producing the acrylic rubber roll according to claim 9, wherein the photoinitiator comprises 2,2-dimethoxy-phenyl ketone.
